(19) United States
(12) Patent Application Publication
(10) Pub. No.: US 2008/0181154 A1
(43) Pub. Date: Jul. 31, 2008

(54) APPARATUS FOR AND METHOD OF LOW POWER WIRELESS LOCAL AREA NETWORK INDEPENDENT BASIC SERVICE SET MODE OPERATION

(75) Inventor: Itay Sherman, Ra'anana (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/669,312

(22) Filed: Jan. 31, 2007

(51) Int. Cl. G08C 17/00; H04Q 7/24

(52) U.S. Cl. 370/311; 370/338

(57) ABSTRACT

A novel and useful apparatus for and method of providing a low power IBSS mode of operation in an ad hoc WLAN. The low power IBSS mechanism enables extremely low power operation when used among stations that implement the mechanism. The mechanism allows the implementation of an IBSS network that is interoperable with standard WLAN IBSS implementations permitting IBSS networks that comprise a mix of stations that implement the mechanism of the present invention with those that do not. Stations synchronize with each other in a manner that takes advantage of the presence of any accurate timing sources, such as the GPS or cellular radio networks. A means is also provided for stations to both advertise the services they are able to support and to discover the services that other stations support in a quick and power efficient manner.

### FIELD OF THE INVENTION

The present invention relates to the field of data communications and more particularly relates to an apparatus for and method of implementing low power independent basic service set (IBSS) mode operation in a wireless local area network (WLAN).

### BACKGROUND OF THE INVENTION

Currently, the trend of anytime an anywhere computing and communication is growing at an ever quicker pace. Wireless communication technology coupled with the available of light weight, powerful, compact and portable computing devices is largely responsible for this rapidly increasing trend. Mobile ad hoc networks (MANETs) are one type of network commonly used to provide anywhere computing. A MANET is a network comprising a number of mobile stations that are able to communicate with each other that do not utilize a base station.

A critical factor for the deployment and use of MANETs, and portable devices in general, is battery power. The power supplied by the batteries within the devices is a limited resource and device designers are constantly devising ways to lengthen the life of batteries. A wireless local area network (WLAN) is one such MANET that relies heavily on batteries for its operation.

A wireless local area network (WLAN) links two or more computers together without using wires. WLAN networks utilize spread-spectrum technology based on radio waves to enable communication between devices in a limited area, also known as the basic service set. This gives users the mobility to move around within a broad coverage area and still be connected to the network.

For the home user, wireless networking has become popular due to the ease of installation and location freedom with the large gain in popularity of laptops. For the business user, public businesses such as coffee shops or malls have begun to offer wireless access to their customers, whereas some are even provided as a free service. In addition, relatively large wireless network projects are being constructed in many major cities.

There are currently there exist several standards for WLANs: 802.11, 802.11a, 802.11b, 802.11g and 802.11n. The 802.11b has a rate of 11 Mbps in the 2.4 GHz band and implements direct sequence spread spectrum (DSSS) modulation. The 802.11a is capable of reaching 54 Mbps in the 5 GHz band. The 802.11g standard also has a rate of 54 Mbps but is compatible with 802.11b. The 802.11a/g implements orthogonal frequency division multiplexing (OFDM) modulation.

A wireless ad hoc network is a computer network in which the communication links are wireless, The network is termed ad hoc because each node is able to forward data for other nodes wherein the decision to which nodes forward data is made dynamically based on the particular network connectivity. This is in contrast to legacy network technology in which some designated nodes, usually comprising custom hardware and known as routers, switches, hubs and firewalls, perform the task of forwarding the data. Minimal configuration and quick deployment make ad hoc networks suitable for emergency situations like natural or human-induced disasters, military conflicts, emergency medical situations, etc.

A network diagram illustrating an example prior art WLAN network is shown in FIG. 1. The example network, generally referenced 10, comprises a WLAN access point 14 (AP) coupled to a wired LAN 22 such as an Ethernet network. The WLAN AP in combination with laptop 16, personal digital assistant (PDA) 18 and cell phone 20, form a basic service group (BSS) 12. A server 24, desktop computers 26, router 28 and Internet 30 (via router 32) are connected to the wired LAN 22.

A WLAN state is any component that can connect into a wireless medium in a network. All stations are equipped with wireless network interface cards (NICs) and are either access points or clients. Access points (APs) are base stations for the wireless network. They transmit and receive radio frequencies for wireless enabled devices to communicate with. Wireless clients can be mobile devices such as laptops, personal digital assistants, IP phones or fixed devices such as desktops and workstations that are equipped with a wireless network interface card.

The basic service set (BSS) is defined as the set of all stations that can communicate with each other. There are two types of BSS: (1) independent BSS and (2) infrastructure BSS. Every BSS has an identification (ID) called the BSSID, which is the MAC address of the access point servicing the BSS. An independent basic service set (BSS) is an ad hoc network that contains no access points, which means the stations within the ad hoc network cannot connect to any other basic service set.

An infrastructure basic service set (BSS) can communicate with other stations that are not in the same basic service set by communicating through access points. An extended service set (ESS) is a set of connected BSSs. Access points in an ESS are connected by a distribution system. Each ESS has an ID called the SSID which is a 32-byte (maximum) character string. A distribution system connects access points in an extended service set. A distribution system is usually a wired LAN but can also be a wireless LAN.

The types of wireless LANs include peer to peer or ad hoc wireless LANs. A peer-to-peer (P2P) WLAN enables wireless devices to communicate directly with each other. Wireless devices within range of each other can discover and communicate directly without involving central access points. This method is typically used by two computers so that they can connect to each other to form a network. If a signal strength meter is used in this situation, it may not read the strength accurately and can be misleading, because it registers the strength of the strongest signal, which may be the closest computer.

As example of a WLAN ad hoc network is shown in FIG. 2. The example ad hoc network, generally referenced 40, comprises a plurality of WLAN stations 42, 44, 26 that together form a IBSS. It is assumed that each station within the IBSS is able to hear transmissions from all the other stations within the IBSS.

A block diagram illustrating an example prior art WLAN transceiver in more detail is shown in FIG. 3. The WLAN transceiver, generally referenced 50, comprises host interface (I/F) 54 in communication with a host device 52, baseband processor/MAC 56, memory 57, PHY circuit 58, WLAN radio 60, controller 64 and power management 66. The radio circuitry 60 comprises the RF switch, bandpass filter, RF front end circuitry, bandpass filter, etc. (not shown). The PHY circuit comprises I and Q signal analog to digital converters (ADCs) and I and Q signal digital to analog converters (DACs) (not shown). The memory 57 comprises any required memory devices such as EEPROM, static RAM, FLASH memory, etc.

The RF front end circuit with the radio functions to filter and amplify RF signals and perform RF to IF conversion to generate I and Q data signals for the ADCs and DACs in the PHY. The baseband processor functions to modulate and demodulate I and Q data, perform carrier sensing, transmission and receiving of frames. The medium access controller (MAC) functions to control the communications (i.e. access) between the host device and applications. The power management circuit 66 is adapted to receive power via a wall adapter, battery and/or power via the host interface 52. The host interface may comprise PCI, CardBus or USB interfaces.

The IEEE 802.11 standard provides for two modes of operation: an active mode and a power saving (PS) mode. Power saving (PS) mode is a power efficient method that prolongs the network operation time of battery powered wireless LAN devices. It is a synchronous protocol which requires precise time synchronization among all the participating stations within the Independent Basic Service Set (IBSS). Therefore, a Time Synchronization Function (TSF) is defined for the protocol to operate without the aid of external timing sources. The standard assumes the stations are time synchronized and thus all PS stations will wake up at about the same time.

Time synchronization is achieved by periodically transmitting a time synchronization beacon, which defines a series of fixed length beacon intervals. The successful beacon serves to synchronize the clocks of the stations in the ad hoc network. The beacon also inhibits other stations from transmitting their beacons. In order to avoid collisions among beacons, stations wait a random number of slots (i.e. backoff period) before transmitting a beacon.

In PS mode for Distributed Coordinated Function (DCF), stations wake up at the beginning of each beacon interval for a time duration window referred to as the Announcement Traffic Indication Message (ATIM) window to announce their pending data packets using small ATIM control packets. The station remains awake for the entire remaining period after transmitting an ATIM frame. Upon reception of an ATIM frame, the power save station replies with an ACK and remains active for the remaining period. After the ATIM window ends, stations transmit the announced data packets using contention based DCF access procedures. If the sender does not receive an ACK, it retries transmission in the next ATIM window.

With reference to the example shown in FIG. 4, station A wants to transmit a packet to station B. During the ATIM window, an ATIM frame is transmitted from station A to station B. Station B, in response, replies with an ACK. After the ATIM window closes, station A attempts to transmit its data packet.

A problem arises, however, in that the power saving mode specified by the IEEE 802.11 standard does not provide significant power saving, especially for the case of an IBSS comprises of only two stations. In addition, the standard does not address the issue of providing low power initial scan and connection establishment.

In addition, the standard does not address the issue of service discoverability. IEEE 802.11 related standards are limited in that they define only the basic L1, L2 connectivity but do not address any higher layers. The layered approach of the standard is problematic, especially when considering the case of the mobile environment. In this environment, the need to establish at least full layer 3 connectivity in order for devices to be ale to probe each other's capabilities to support different applications, is a major limiting factor.

It is thus desirable to have a mechanism that is capable of significantly reducing the power consumed while a WLAN station is in the ad hoc power saving mode of operation. In particular, a mechanism is needed that is capable of synchronizing the stations in an ad hoc IBSS that uses less power than prior art procedure. In addition, a mechanism is needed that is capable that enables stations to discover the capabilities of other stations quickly without the need to first establish layer 3 connectivity.

### SUMMARY OF THE INVENTION

The present invention is a novel and useful apparatus for and method of providing a low power IBSS mode of operation in an ad hoc WLAN. The low power IBSS mechanism of the present invention enables extremely low power operation when used among stations that implement the mechanism. The low power IBSS mechanism of the present invention allows the implementation of an IBSS network that is interoperable with standard WLAN IBSS implementations. Thus, IBSS networks can be created that comprise a mix of stations that implement the mechanism of the present invention with conventional stations that do not implement the invention. In addition, the low power IBSS mechanism of the present invention provides a means for stations to both advertise the services they are able to support and to discover the services that other stations support in a quick and power efficient manner.

In operation, stations synchronize with each other in a manner that takes advantage of the presence of any accurate timing sources, such as the GPS or cellular radio networks. If a station has access to an accurate timing source, it is used to synchronize the stations within the IBSS.

Although the mechanism of the present invention can be used in numerous types of communication systems, to aid in illustrating the principles of the present invention, the description of the low power IBSS mechanism is provided in the context of a WLAN radio enabled communication device such as a cellular phone.

Although the low power IBSS mechanism of the present invention can be incorporated in numerous types of WLAN enabled communication devices such a multimedia player, cellular phone, PDA, etc., it is described in the context of a cellular phone. It is appreciated, however, that the invention is not limited to the example applications presented, whereas one skilled in the art can apply the principles of the invention to other communication systems as well without departing from the scope of the invention.

The low power IBSS mechanism has several advantages including the following: (1) use of existing silicon solutions wherein the mechanism can be implemented in firmware; (2) the mechanism of the present invention is interoperable with standard based WLAN stations; and (3) use of the mechanism of the present invention provides over 90% lower power consumption than conventional ad hoc power save mode operation.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application. Specific Integrated Circuit (ASIC) or Field Programmable Gate Array (FPGA), or as functionally equivalent discrete hardware components.

### BRIEF DESCRIPTION OF THE DRAWINGS

The invention is herein described, by way of example only, with reference to the accompanying drawings, wherein:

FIG. 1 is a network diagram illustrating an example prior art wireless LAN network;

FIG. 2 is a network diagram illustrating an example ad hoc IBSS wireless LAN network;

FIG. 3 is a block diagram illustrating an example prior art WLAN transceiver in more detail;

FIG. 4 is a diagram illustrating power management in prior art ad hoc wireless LAN networks;

FIG. 5 is a network diagram illustrating an example IBSS network having WLAN stations that implement the low power IBSS mechanism of the present invention;

FIG. 6 is a block diagram illustrating an example communication device in more detail incorporating the low power IBSS mechanism of the present invention;

FIG. 7 is a block diagram illustrating an example WLAN station that implements the low power IBSS mechanism of the present invention in more detail;

FIG. 8 is a diagram illustrating the time synchronization method of the present invention;

FIG. 9 is a diagram illustrating the possible states of the WLAN station of the present invention;

FIG. 10 is a diagram illustrating the sync time information element;

FIG. 11 is a flow diagram illustrating the discovery method of the present invention;

FIG. 12 is a diagram illustrating the identity information element;

FIG. 13 is a diagram illustrating the temporary identity information element;

FIG. 14 is a diagram illustrating the station services information element;

FIG. 15 is a diagram illustrating the network services information element;

FIG. 16 is a diagram illustrating the station services record;

FIG. 17 is a flow diagram illustrating the service discovery method of the present invention;

FIG. 18 is a flow diagram illustrating the IBSS power save method of the present invention;

FIG. 19 is a flow diagram illustrating the method of the present invention of switching between connected and scan states; and

FIG. 20 is a diagram illustrating an example IBSS network.

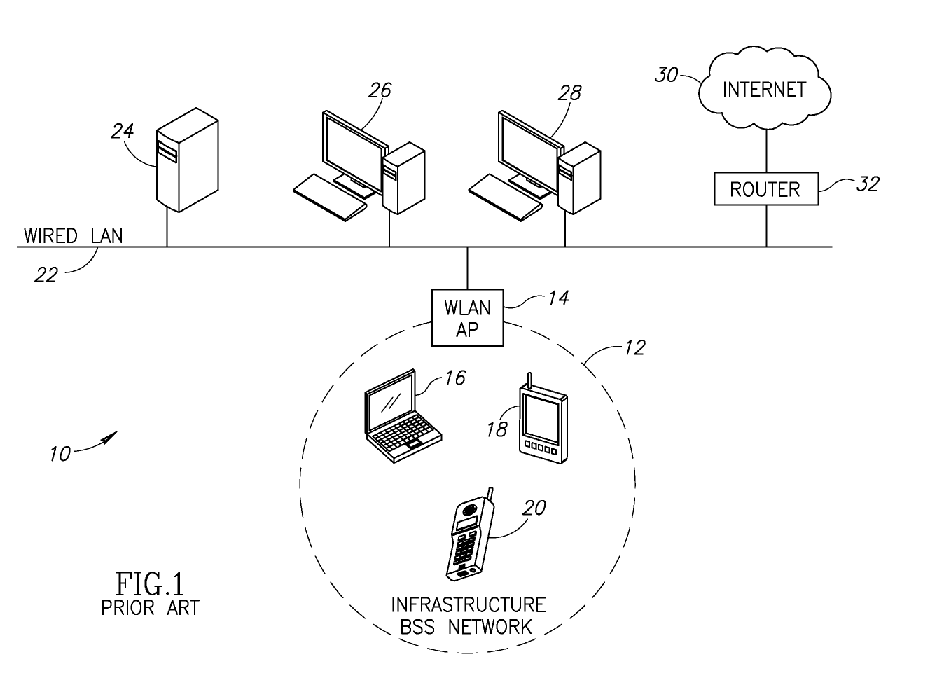

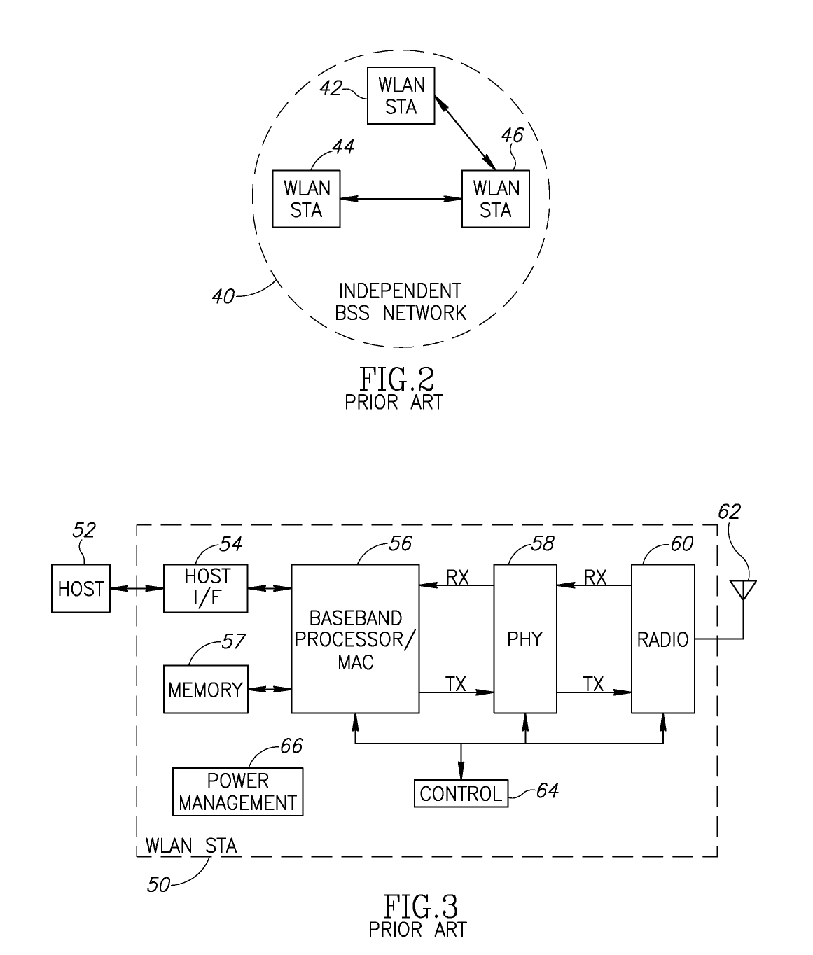

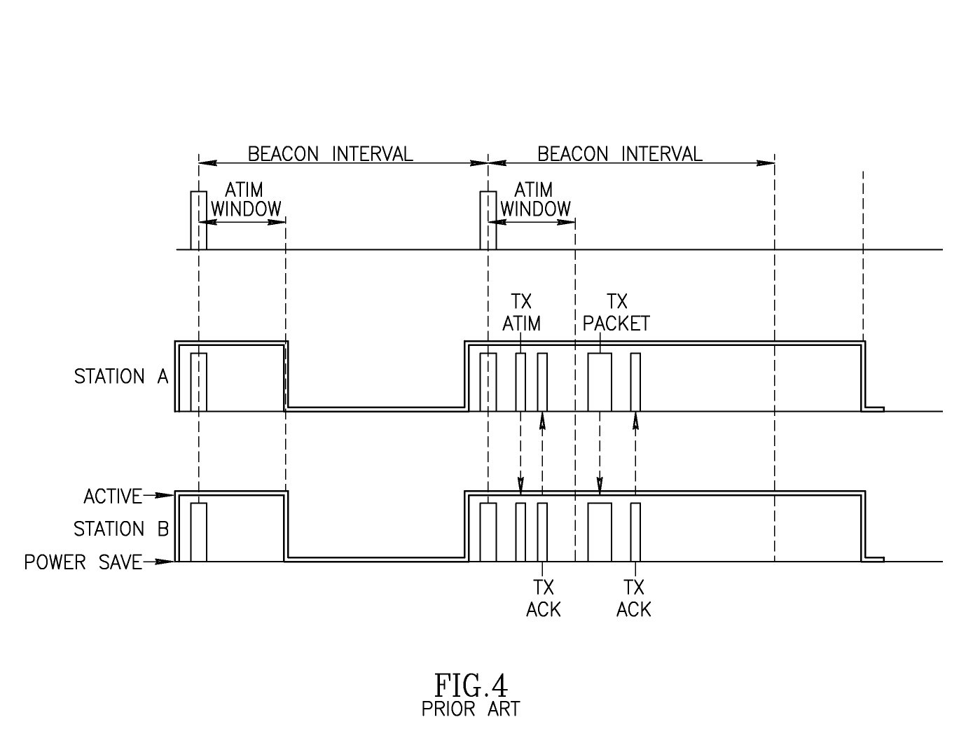

### DETAILED DESCRIPTION OF THE INVENTION

### Notation Used Throughout

The following notation is used throughout this document.

| Term | Definition |
|---|---|
| AC | Alternating Current |
| ADC | Analog to Digital Converter |
| AIFS | Arbitration Inter-Frame Space |
| AP | Access Point |
| API | Application Programming Interface |
| ASIC | Application Specific Integrated Circuit |
| ATIM | Announcement Traffic Indication Message |
| AVI | Audio Video Interleave |
| BMP | Windows Bitmap |
| BSS | Basic Service Set |
| CPU | Central Processing Unit |
| CW | Contention Window |
| DAC | Digital to Analog Converter |
| DC | Direct Current |
| DCF | Distributed Coordinating Function |
| DSP | Digital Signal Processor |
| DSSS | Direct Sequence Spread Spectrum |
| DTIM | Delivery Traffic Indication Message |
| EEPROM | Electrically Erasable Programmable Read Only Memory |
| EPROM | Erasable Programmable Read Only Memory |
| ESS | Extended Service Set |
| FM | Frequency Modulation |
| FPGA | Field Programmable Gate Array |
| GPS | Ground Positioning Satellite |
| HDL | Hardware Description Language |
| I/F | Interface |
| IBSS | Independent Basic Service Set |
| ID | Identification |
| IE | Information Element |
| IEEE | Institute of Electrical and Electronics Engineers |
| IP | Internet Protocol |
| JPG | Joint Photographic Experts Group |
| LAN | Local Area Network |
| MAC | Media Access Control |
| MANET | Mobile Ad Hoc Network |
| MP3 | MPEG-1 Audio Layer 3 |
| MPG | Moving Picture Experts Group |
| NIC | Network Interface Card |
| OFDM | Orthogonal Frequency Division Multiplexing |
| P2P | Peer to Peer |
| PC | Personal Computer |
| PCI | Personal Computer Interconnect |
| PDA | Portable Digital Assistant |
| RAM | Random Access Memory |
| RF | Radio Frequency |
| ROM | Read Only Memory |
| SIM | Subscriber Identity Module |
| SSID | Service Set Identifier |
| STA | Station |
| TBTT | Target Beacon Transmit Time |
| TSF | Time Synchronization Function |
| TU | Time Unit |
| TV | Television |
| USB | Universal Serial Bus |
| UWB | Ultra Wideband |
| WiFi | Wireless Fidelity |
| WiMax | Worldwide Interoperability for Microwave Access |
| WiMedia | Radio platform for UWB |
| WLAN | Wireless Local Area Network |
| WMA | Windows Media Audio |
| WMV | Windows Media Video |

### DETAILED DESCRIPTION OF THE INVENTION

The present invention is a novel and useful apparatus for and method of providing a low power IBSS mode of operation in an ad hoc WLAN. The low power IBSS mechanism enables extremely low power operation when used among stations that implement the mechanism. The mechanism allows the implementation of an IBSS network that is interoperable with standard WLAN IBSS implementations permitting IBSS networks that comprise a mix of stations that implement the mechanism of the present invention with those that do not. Stations synchronize with each other in a manner that takes advantage of the presence of any accurate timing sources, such as the GPS or cellular radio networks. A means is also provided for stations to both advertise the services they are able to support and to discover the services that other stations support in a quick and power efficient manner.

Although the mechanism of the present invention can be used in numerous types of communication systems, to aid in illustrating the principles of the present invention, the description of the low power IBSS mechanism is provided in the context of a WLAN radio enabled communication device such as a cellular phone.

Although the low power IBSS mechanism of the present invention can be incorporated in numerous types of WLAN enabled communication devices such a multimedia player, cellular phone, PDA, etc., it is described in the context of a cellular phone. It is appreciated, however, that the invention is not limited to the example applications presented, whereas one skilled in the art can apply the principles of the invention to other communication systems as well without departing from the scope of the invention.

Note that throughout this document, the term communications device is defined as any apparatus or mechanism adapted to transmit, receive or transmit and receive data through a medium. The term communications transceiver or communications device is defined as any apparatus or mechanism adapted to transmit and receive data through a medium. The communications device or communications transceiver may be adapted to communicate over any suitable medium, including wireless or wired media. Examples of wireless media include RF, infrared, optical, microwave, UWB, Bluetooth, WiMax, WiMedia, WiFi, or any other broadband medium, etc. Examples of wired media include twisted pair, coaxial, optical fiber, any wired interface (e.g., USB, Firewire, Ethernet, etc.). The term Ethernet network is defined as a network compatible with any of the IEEE 802.3 Ethernet standards, including but not limited to 10Base-T, 100Base-T or 1000Base-T over shielded or unshielded twisted pair wiring. The terms communications channel, link and cable are used interchangeably.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.). The user input means is typically formed of one or more manually operated switches, buttons, wheels or other user input means. Examples of multimedia devices include pocket sized personal digital assistants (PDAs), personal media player/recorders, cellular telephones, handheld devices, and the like.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### EXAMPLE IBSS NETWORK

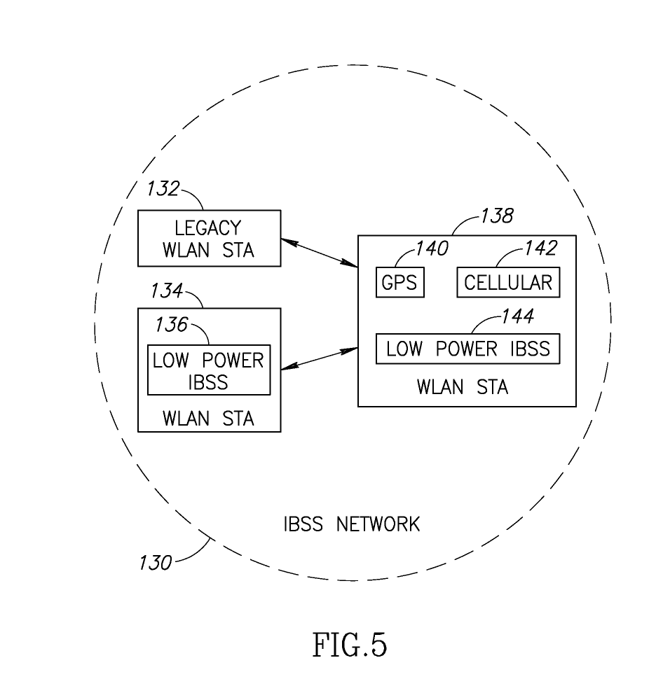

A block diagram illustrating an example IBSS network comprising the low power IBSS mechanism of the present invention is shown in FIG. 5. The IBSS network, generally referenced 130, comprises a plurality of WLAN stations 132, 134, 138. WLAN station 132 comprises a legacy station that implements conventional WLAN ad hoc network features. WLAN station 134 implements the low power IBSS mechanism (block 136) of the present invention but does not have access to an accurate timing source (either internal or external). WLAN station 138 also implements the low power IBSS mechanism (block 144) of the present invention but does have access to at least one accurate timing source. In this example, station 144 comprises a GPS radio 140 and cellular radio 142.

As described in more detail infra, the low power IBSS mechanism is capable of synchronizing all the WLAN stations in the IBSS regardless of whether they implement the mechanism of the invention and regardless of whether they have access to accurate timing information as well.

### Mobile Device/Cellular Phone/PDA System

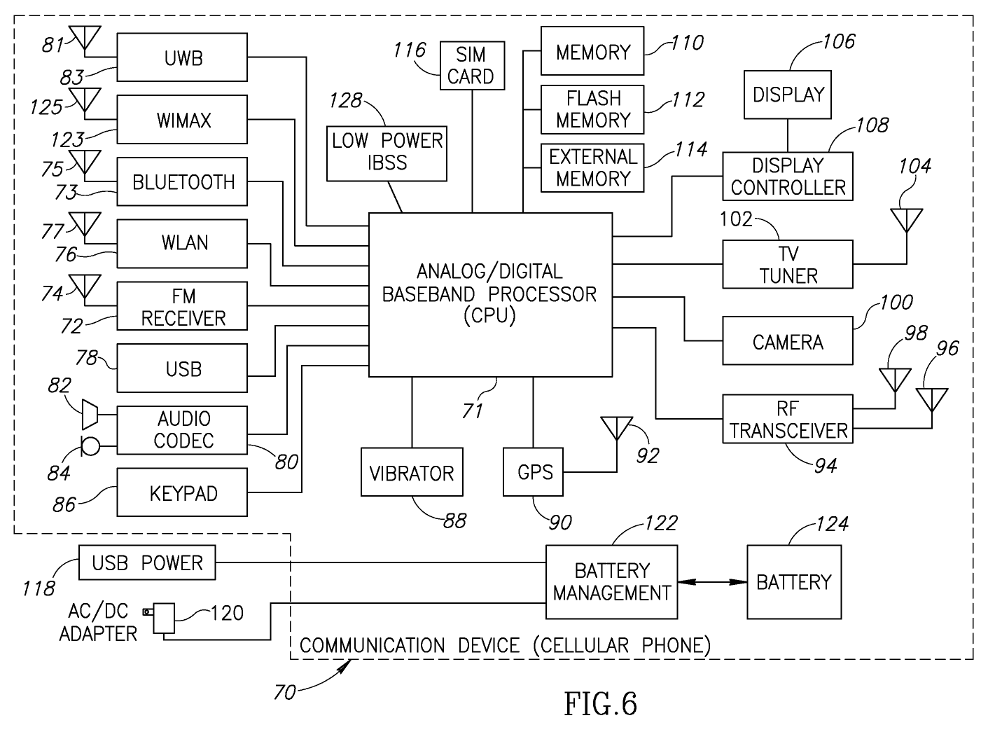

A block diagram illustrating an example communication device in more detail incorporating the low power IBSS mechanism of the present invention is shown in FIG. 6. The communication device may comprise any suitable wired or wireless device such as multimedia player, mobile device, cellular phone, PDA, Bluetooth device, etc. For illustration purposes only, the communication device is shown as a cellular phone. Note that this example is not intended to limit the scope of the invention as the WLAN signal detection mechanism of the present invention can be implemented in a wide variety of communication devices.

The cellular phone, generally referenced 70, comprises a baseband processor or CPU 71 having analog and digital portions. The basic cellular link is provided by the RF transceiver 94 and related one or more antennas 96, 98. A plurality of antennas is used to provide antenna diversity which yields improved radio performance. The cell phone also comprises internal RAM and ROM memory 110, Flash memory 112 and external memory 114.

Several user interface devices include microphone 84, speaker 82 and associated audio codec 80, a keypad for entering dialing digits 86, vibrator 88 for alerting a user, camera and related circuitry 100, a TV tuner 102 and associated antenna 104, display 106 and associated display controller 108 and GPS receiver and associated antenna 92.

A USB interface connection 78 provides a serial link to a user's PC or other device. An FM receiver 72 and antenna 74 provide the user the ability to listen to FM broadcasts. WLAN radio and interface 76 and antenna 77 provide wireless connectivity when in a hot spot or within the range of an ad hoc, infrastructure or mesh based wireless LAN network. A low power radio (such as Bluetooth radio) and interface 73 and antenna 75 provide Bluetooth wireless connectivity when within the range of a Bluetooth wireless network. A key characteristic of the Bluetooth or other low power radio is that the power consumed by the receiver is lower than that of the WLAN radio when in the idle mode of operation. Alternatively, the communication device 70 may comprise an Ultra Wideband (UWB) radio and/or WiMAX radio and respective interfaces (not shown). SIM card 116 provides the interface to a user's SIM card for storing user data such as address book entries, etc.

The cellular phone also comprises a WLAN transmission detection block 128 adapted to implement the WLAN signal detection mechanism of the present invention as described in more detail infra. In operation, the WLAN signal detection block 128 may be implemented as hardware, software executed as a task on the baseband processor 71 or a combination of hardware and software. Implemented as a software task, the program code operative to implement the WLAN signal detection mechanism of the present invention is stored in one or more memories 110, 112 or 114.

Portable power is provided by the battery 124 coupled to battery management circuitry 122. External power is provided via USB power 118 or an AC/DC adapter 120 connected to the battery management circuitry which is operative to manage the charging and discharging of the battery 124.

### EXAMPLE WLAN STA

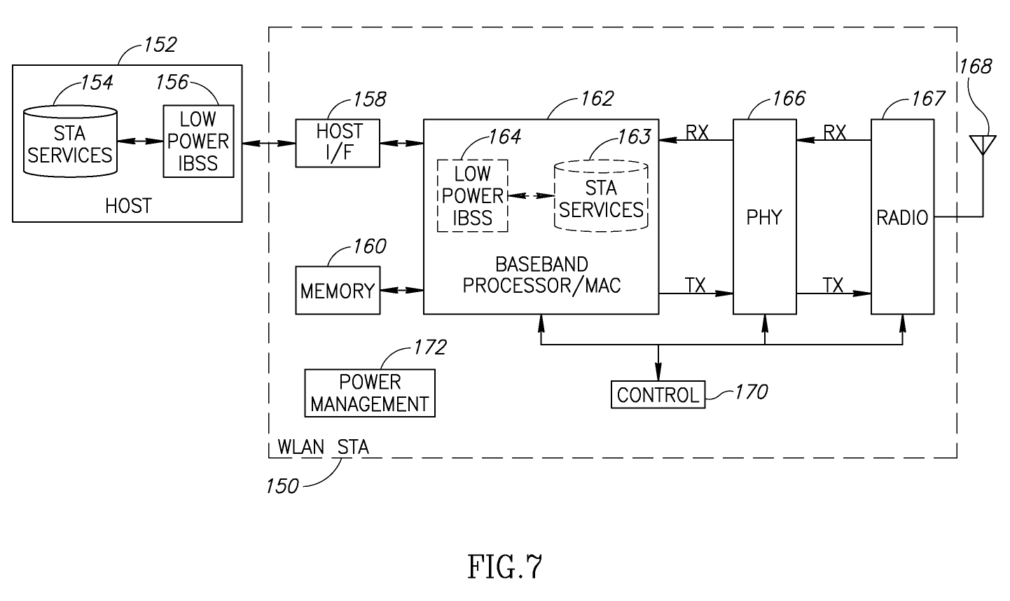

A block diagram illustrating an example WLAN station that implements the low power IBSS mechanism of the present invention in more detail is shown in FIG. 7. The WLAN transceiver (i.e. station or STA), generally referenced 150, comprises host interface (I/F) 158 in communication with a host device 152, baseband processor/MAC 162, memory 160, PHY circuit 166, WLAN radio 167, controller 170 and power management 172. The radio circuitry 166, coupled to antenna 168, comprises the RF switch, bandpass filter, RF front end circuitry, bandpass filter, etc. (not shown). The PHY circuit 166 comprises I and Q signal analog to digital converters (ADCs) and I and Q signal digital to analog converters (DACs) (not shown). The memory 160 comprises any memory devices such as EEPROM, static RAM, FLASH memory, etc. necessary for operation of the processor/MAC. Note that in one embodiment, the mechanism of the invention is implemented as firmware/software that resides in memory 160 and executed on the baseband processor or other controller device, referenced as the dashed block 164 in communication with STA services database 163. Alternatively, the mechanism may be implemented in the host or a combination of the host and baseband processor. If implemented in the host, block 156 communicates with STA services database 154.

The RF front end circuit with the radio functions to filter and amplify RF signals and perform RF to IF conversion to generate I and Q data signals for the ADCs and DACs in the PHY. The baseband processor functions to modulate and demodulate I and Q data, perform carrier sensing, transmission and receiving of frames. The medium access controller (MAC) functions to control the communications (i.e. access) between the host device and applications. The power management circuit 172 is adapted to receive power via a wall adapter, battery and/or power via the host interface 158. The host interface may comprise PCI, CardBus or USB interfaces.

### Time Synchronization and Initial Discovery

The standard implementation of an IBSS requires a STA to perform active or passive scan as well as generate beacons and stay in the awake (i.e. active) state in order to ensure both the ability to discover other STA as well to make that particular STA discoverable by others. The low power IBSS mechanism enables STAs to perform synchronized passive scanning while sleeping between scan periods. The procedure is based on specific time synchronization and scan and beacon broadcasting procedures described infra.

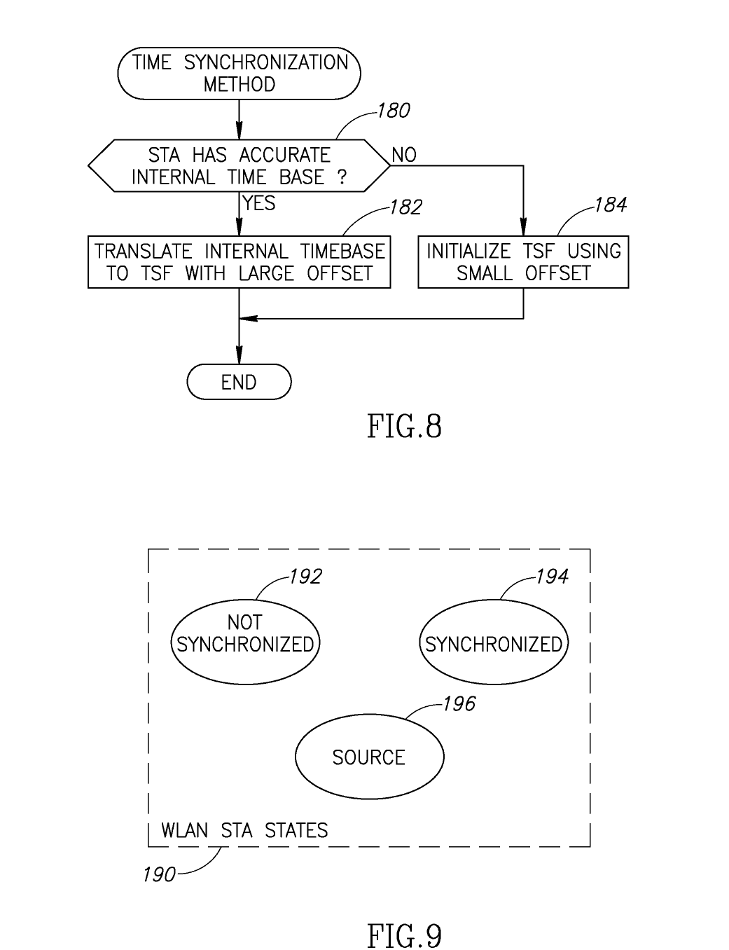

A diagram illustrating the time synchronization method of the present invention is shown in FIG. 8. STAs use accurate timing information in order to synchronize their time base as expressed by a time synchronization function (TSF). Accurate timing information is acquired internally within the device from accurate time sources (either external or internal) such as (1) the cellular network time base, (2) the GPS clock received from the GPS network, or (3) in the event the particular STA does not have access to an accurate timing source, by synchronizing to other WLAN STAs that do have access to at least one accurate timing clock source.

With reference to FIG. 8, it is first determined whether the STA has access to an accurate timing source (step 180). If is does, than the accurate timebase information is translated to the TSF using a relatively large offset value that is chosen to force other STAs to synchronize to it rather than other STAs (step 182). If the STA does not have an accurate timing source (step 180), the TSF generated uses a relatively small offset that is chosen to force the particular STA to synchronize to a STA that does have access to an accurate timing source (step 184).

As an example, assuming a STA has access to an internal accurate clock source, timing information from the timing source is translated to a TSF in accordance with the following:

TSF=0x80000000 0x00000000+Absolute time from year start in microseconds

If the STA does not have access to an internal accurate clock source, the TSF will be initialized to 0x40000000 0x00000000.

It is important to note that the offset injected into the TSF is different for each case. The larger offset (i.e. 0x80000000) is operative to force standard ad hoc STAs to synchronize to the time base of the ad hoc STAs that both implement the mechanism of the invention and have access to an accurate timing source, rather than vice versa. The smaller offset (i.e. 0x40000000) is operative to force STAs that implement the mechanism of the invention but do not have access to an accurate timing source to synchronize to STAs that implement the mechanism of the invention and do have such access to an accurate timing source.

Therefore, a WLAN STA can be in one of three states, as shown FIG. 9. The three states (referenced 190) are (1) Not Synchronized 192, (2) Synchronized 194, and Source 196. The Not Synchronized state 192 is the state wherein the WLAN STA does not have access to an accurate clock timing source or it is not active and the particular STA did not synchronize with any other STA that was exposed to such an accurate clock source for a certain period of time. The Synchronized state 194 is the state wherein the particular STA device had synchronized it's clock in the previous SYNC_TIMEOUT period with STA devices that had access to an accurate clock information source. The Source state 196 is the state wherein the particular STA device includes an internal accurate clock timing source and it is used to synchronize the entire network.

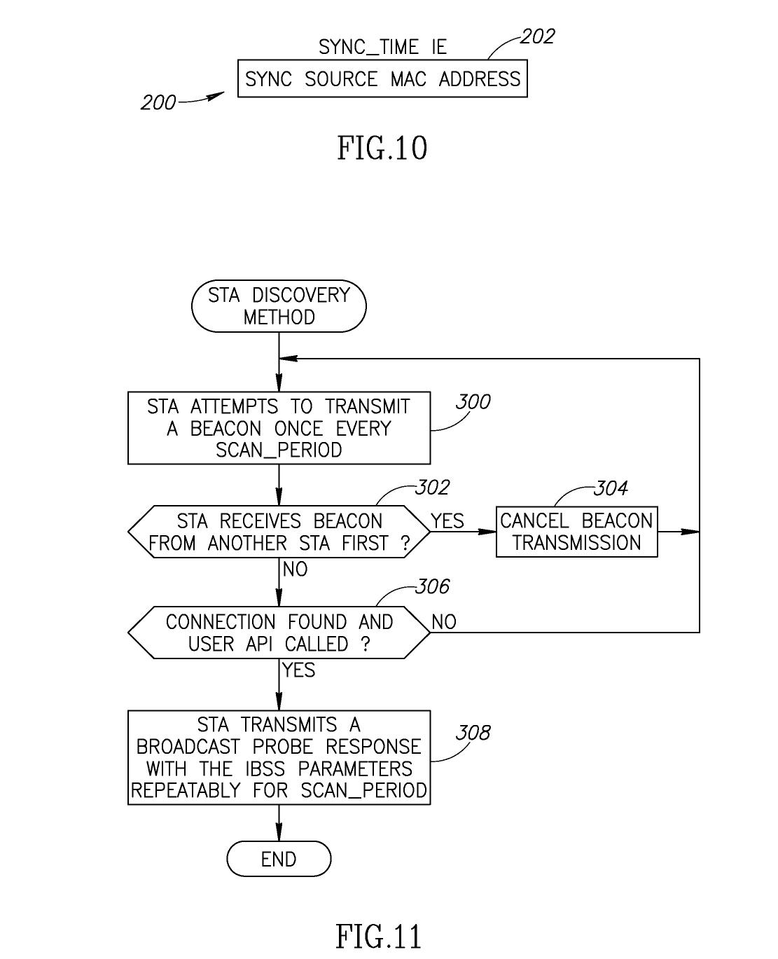

A STA implementing the low power IBSS mechanism includes a SYNC_TIME IE in it's beacon and probe requests and responses. A diagram illustrating the sync time information element is shown in FIG. 10. The SYNC_TIME IE comprises a 6-byte MAC address field of the synchronization source that is interpreted as follows. A zero for the MAC address indicates that the particular STA is not synchronized. A MAC address of itself indicates that the low power IBSS STA is a source that has access to an accurate timing source. A MAC address of another STA indicates that the STA is synchronized to another STA having that particular MAC address.

If a STA that is a Source has not internally synchronized for a period of SYNC_TIMEOUT then it will change its state to the Not Synchronized state. If a STA that is in the Synchronized state is not being synchronized by its Source STA for a period of SYNC_TIMEOUT then it performs the following steps: (1) if it does not have an internal clock timing source it will change its source indication to Not Synchronized, and (2) if it does have a internal clock timing source then it switches to the Source state.

A STA performs a timing update according to the rules defined in the IEEE 802.11 standard (i.e. it adopts the TSF of other STAs if their TSF is higher then its own) with the following modifications, however. A STA that is Synchronized or a Source will not update its TSF from a STA that is not Synchronized. A STA that is not Synchronized updates its TSF even if its TSF is higher then the TSF received from another STA, if the received TSF is Source or Synchronized.

A STA that is Synchronized to another STA includes the other STA MAC address in its SYNC_TIME IE. A STA that is Source includes its own MAC address. If the time update causes an update that is smaller then MAX_DRIFT, then the STA updates its TSF immediately.

If the time update causes an update that is larger or equal to MAX_DRIFT, then the STA sends OVERLAP_BEACON_COUNT beacons according to the previous TSF timing but includes the new TSF and DTIM count reflecting the new TSF. During this period of time the STA also sends beacons on the new timing as well. This procedure allows other STAs to receive the beacons with the timing update and adopt their TSF accordingly.

A STA whose state switches from Synchronized to Source also performs the described procedure for double beaconing. A STA that joins/unifies the IBSS performs the procedure described above as well. A STA that is not connected and has an internal accurate clock source reports itself as a Source.

The process of discovering other STAs will now be described. The STA performs a passive background scan once in SCAN_PERIOD seconds. The following parameters are used:

Frequency_index=Hash(SSID)mod(Regulatory domain)

Scan time offset=Hash(SSID)mod(SCAN_PERIOD/BEACON_PERIOD)*BEACON_PERIOD

where Frequency_index is a pointer to the table of valid frequencies on the particular regulatory domain in use.

The Scan lasts for a period of ATIM_WINDOW. In addition to the scan procedure described above, an additional scan is performed for SCAN_PERIOD seconds on the channel as described above. This scan will be performed if a user API is called (i.e. the user asks for a scan list) or an application attempts to send data through the WLAN connection to a STA that is not active or the STA just started operating.

The process of enabling the discoverability of the STA will now be described. A flow diagram illustrating the discovery method of the present invention is shown in FIG. 11. The STA attempts to transmit a beacon once every SCAN_PERIOD second (step 300) using the frequency and timing as described above. Note that transmitting the beacon and passive scanning are performed simultaneously. If the STA receives another STA beacon before it is able to transmit its own beacon (step 302), it cancels the beacon transmission (step 304).

If no connection is found and a specific user API is called (i.e. the user requests a scan list) or an application attempts to send data through the WLAN connection (step 306), then the following procedure is invoked. The STA transmits on the above calculated frequency a broadcast Probe Response with the parameters of the IBSS (step 308). The Probe Response frames are sent repeatedly for SCAN_PERIOD seconds. The interval coincides with the SCAN_PERIOD second scan interval described above. This procedure insures that even if one of the STAs is not time synchronized, the STA attempting to make the connection will be able to synchronize on the other STA within SCAN_PERIOD seconds.

A discussion of the selection of parameter values follows. The higher the value of SCAN_PERIOD, the lower the resultant power consumption when in search mode. The initial time for connection establishment in case of unsynchronized STAs is, however, increased. A reasonable value for SCAN_PERIOD is 2000 TU (i.e. 2.048 seconds). The value of MAX_DRIFT is configured preferably to the wake up buffer time used by receivers to wake up before TBTT. The time is preferably in the order of 1 msec. The value of OVERLAP_BEACON_COUNT is configured preferably large enough to compensate for accidental loss of beacon reception but should not be too large as to increase the power consumption and bandwidth requirements due to double beaconing. A reasonable number for this value is 3. The value of SYNC_TIMEOUT is configured preferably long enough to allow for STAs that are Sources to transmit multiple beacons. Thus, it should be set to SOURCE_CW*SCAN_PERIOD*OVERLAP_BEACON_COUNT=24000 TU (˜25 seconds).

It is important to note that a benefit of the mechanism of the invention of using an accurate timing source to provide timing for the entire IBSS is that a lower scan time is possible due to the ability to activate scanning on a particular frequency and during a particular time window(s) based on the accurate timing source.

### Services and Identity Advertising

A STA that implements the mechanism of the invention includes in its beacons the following information elements (IEs) described below.

Identity IE:

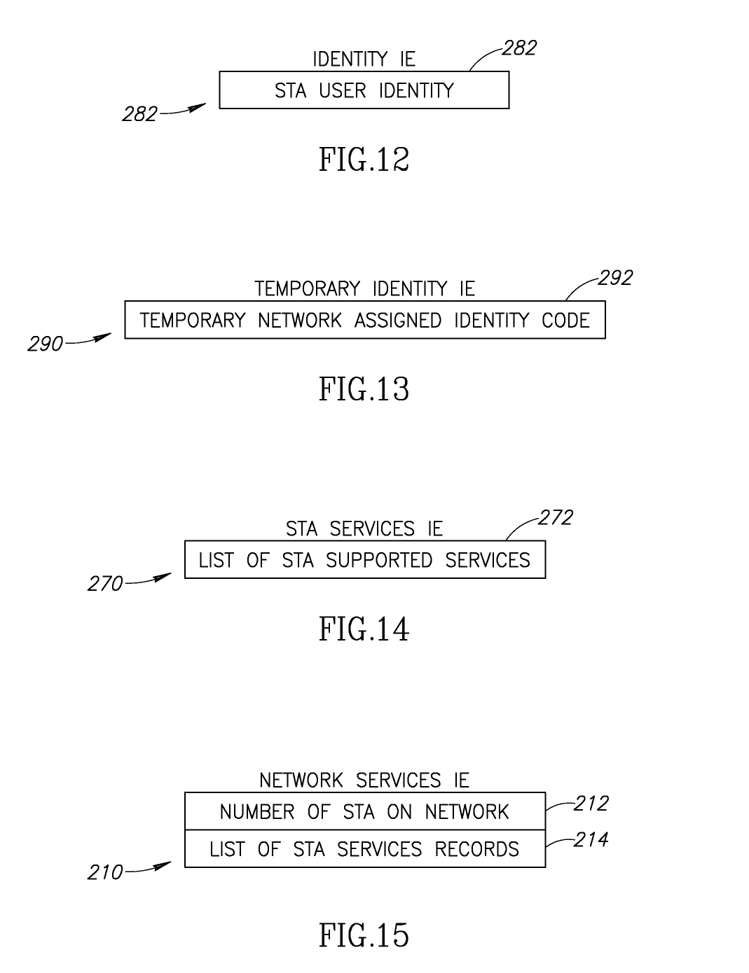

The Identity information element is shown in FIG. 12. The Identity IE, generally referenced 280, comprises a string that represents the identity of the STA user 282. It is used to identify the user for non network controlled peer to peer applications. The user identity is exposed to the world.

Temporary Identity IE:

The Temporary Identity IE is shown in FIG. 13. The Temporary Identity IE, generally referenced 290, comprises an 8-byte value that represents the temporary network assigned identity code 292. It is used for network controlled services. The network is used for directory services and also provides selective identity exposure (i.e. a user may define that his identity is to be revealed only to a limited set of identified users, similar to ICQ policies).

STA Services IE:

The STA Services IE is shown in FIG. 14. The STA Services IE, generally referenced 270, comprises a list of services supported by the specific STA 272. It comprises of the length of the list and a list of service codes, each service code comprising 4-bytes. It is used by devices to identify the services and applications supported by peer devices. A portion of the code is public and has fixed assignments, and others are operator specific wherein their description is stored in the network.

A STA makes a service information inquiry by including in its Probe Request a STA Services IE as described above. This serves to indicate that the STA is requesting to receive a list of all the STAs in the IBSS with the services they support from the requested list. A blank STA Service IE is used to indicate that the STA wishes to receive a list of all services.

A STA reports service information by including in its Probe Response a Network Services IE if the Probe Request includes a STA Services IE. The Network Services IE is shown in FIG. 15. The Network Services IE, generally referenced 210, comprises (1) the number of STAs on network 212 and (2) a list of STA Services Records 214.

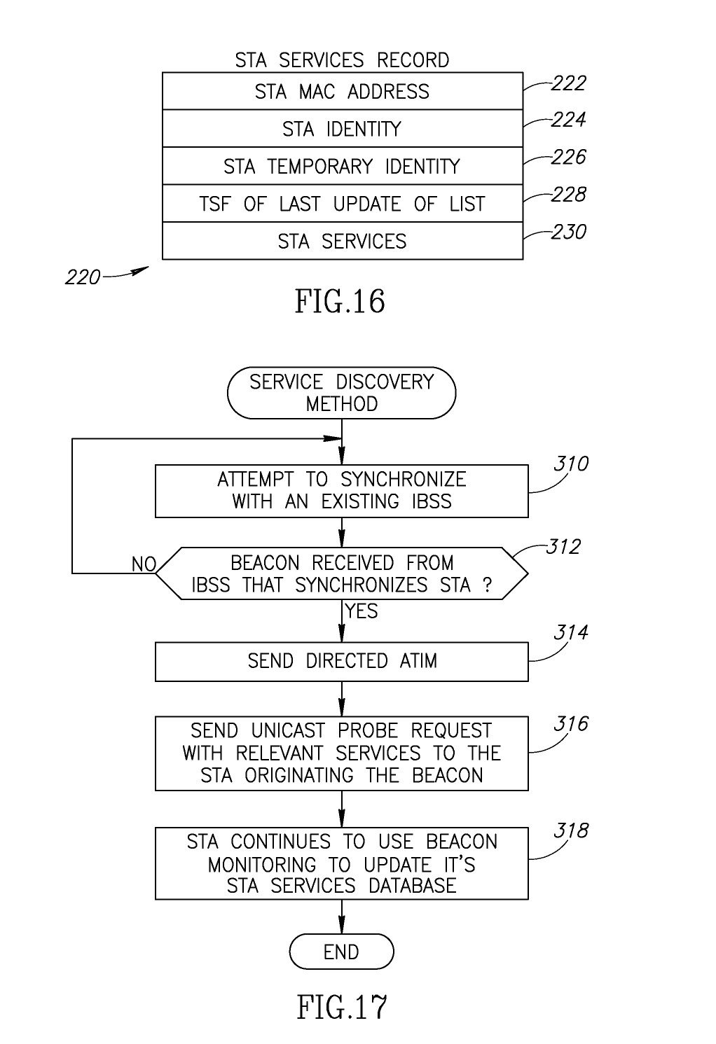

The STA Services Record is shown in FIG. 16. Each STA Services Record, generally referenced 220, comprises (1) STA MAC address 222, (2) STA Identity IE 224, Temporary Identity IE 226, (3) TSF of last update of list 228, and (4) STA Services IE 230 (as defined above). The services listed are only those included in the Probe Request STA Services IE. If no services are included in the Probe Request STA Services IE, all services are included in the Network Services IE.

The mechanism of the invention also provides network services monitoring wherein a STA maintains a database 154, 163 (FIG. 7) of all STA services in the IBSS as reported in their STA Services IE in beacons and or as reported in the Probe Response Network Services IE. The database also stores a timestamp of the receipt of the last update to the list of services associated with a specific STA. The timestamp is updated according to the time of receipt in the case of a received STA Services IE, and in accordance with the timestamp included in the IE in the case of a received Network Services IE.

The STA Services database is reported after filtering of the relevant services in the Probe Response. STA records are phased out if the STA is considered to be inactive (i.e. no traffic or a beacon received from it for STA_INACTIVITY_TIME.

A flow diagram illustrating the service discovery method of the present invention is shown in FIG. 17. The expected behavior of a STA that implements the mechanism of the invention is to initially attempt to synchronize with an existing IBSS (step 310). If a beacon is received from the IBSS that synchronizes the STA (step 312), the STA sends a directed ATIM (step 314) followed by a unicast Probe Request with the relevant services to the STA originating the beacon (step 316), otherwise, the method returns to step 310. This enables the STA to quickly acquire information on all other STA in the IBSS and the services they support. The STA then continues to use beacon monitoring in order to update its STA Services database (step 318).

### IBSS Power Save Operation

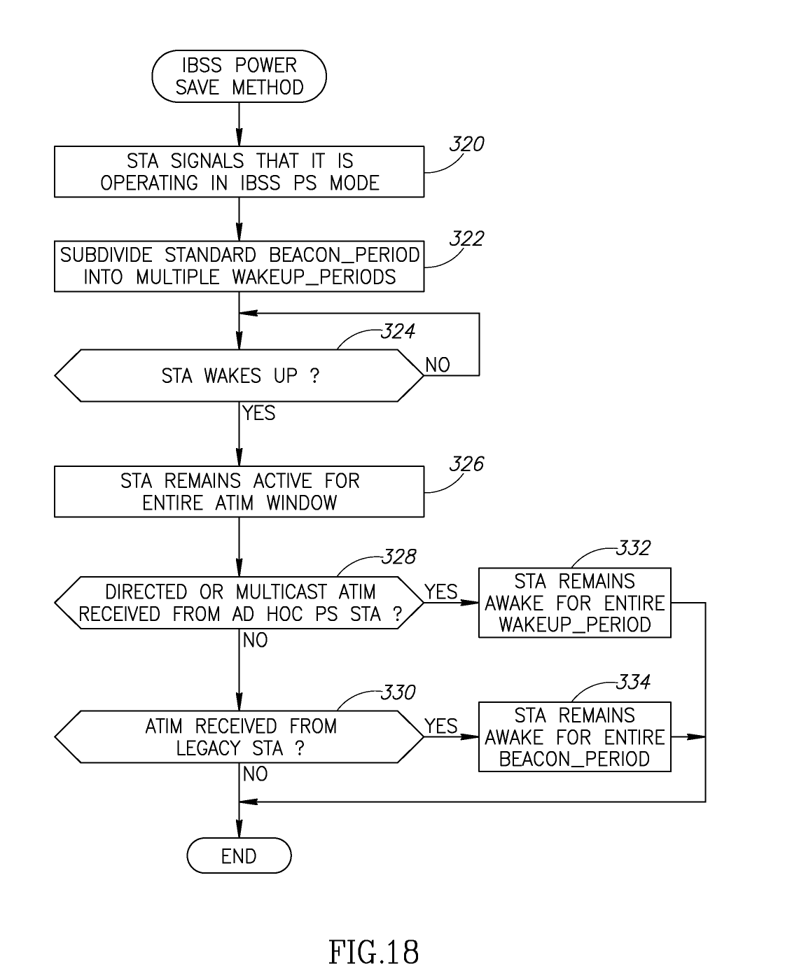

A flow diagram illustrating the IBSS power save method of the present invention is shown in FIG. 18. In power save (PS) mode operation, the STA signals the fact that it is operating in IBSS PS mode using the standard IE (step 320). The standard BEACON_PERIOD is subdivided into multiple WAKEUP_PERIODs, wherein the number of WAKEUP_PERIODs is preferably an integral division of the BEACON_PERIOD (step 322). The STA awakes each WAKEUP_PERIOD, but attempts to transmit beacons only on every BEACON_PERIOD. When the STA wakes up (step 324) it remains active for the entire ATIM window (step 326).

If a directed or multicast ATIM is received from an ad hoc STA of the invention (step 328) then the STA remains awake for the entire WAKEUP_PERIOD (step 332). If the ATIM was received from a legacy STA (step 330), then the ad hoc STA of the invention remains awake for the entire BEACON_PERIOD (step 334). In the case of a legacy STA that does not support ad hoc PS, a STA of the invention still attempts to perform its PS sequence, but remains awake after receiving any frame from that legacy STA for a period of at least WAKEUP_PERIOD.

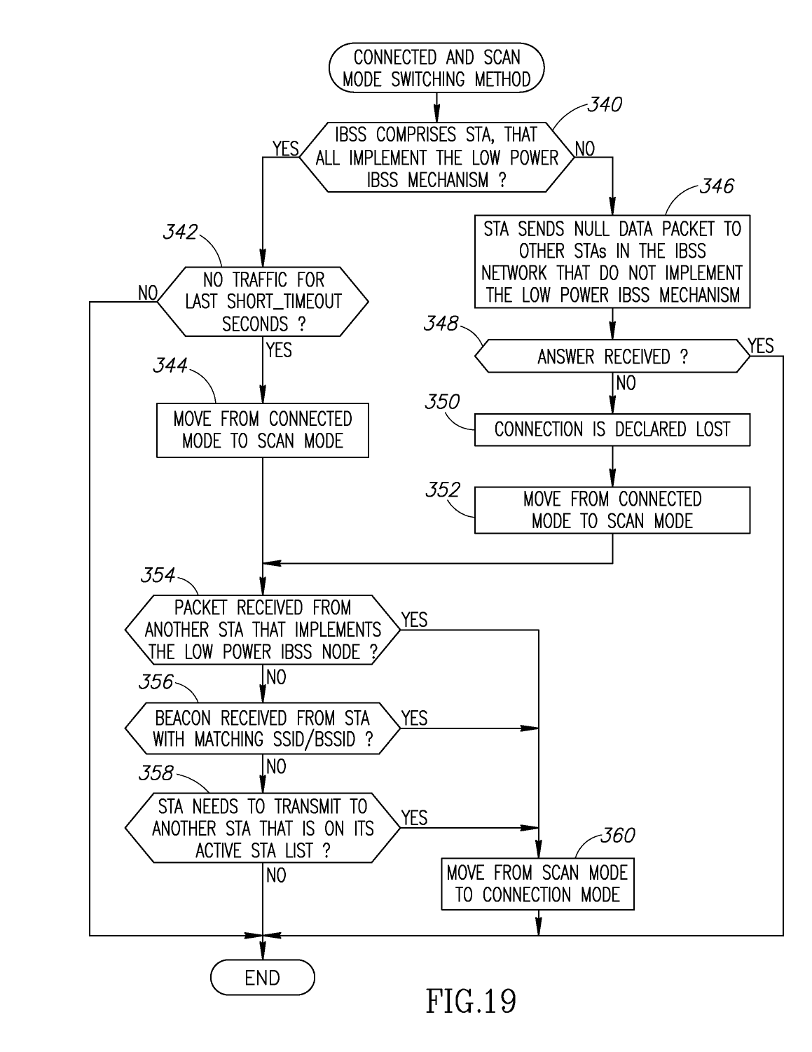

STAs of the present invention switch between connected mode and scan mode according to traffic density and the type of STAs in the IBSS. A flow diagram illustrating the method of the present invention of switching between connected and scan states is shown in FIG. 19. If the IBSS is composed of STAs that all implement the mechanism of the present invention (step 340), then if no traffic was exchanged with it for the last Short_Timeout seconds (step 342), then the STA switches from the connected mode to the scan mode (step 344).

If the IBSS includes STA that does not implement the mechanism of the invention (step 340), then the STA only switches to the scan mode in the event of a connection loss. The connection loss is determined after a period of Long_Timeout seconds. In this case, the STA sends a null data packet to the other STAs in the IBSS network that do not implement the mechanisms of the invention (step 346). If none of the STAs answers (step 348), the connection is determined to be lost (step 350) and the STA returns to scan mode (step 352).

If a packet is received from another STA that implements the mechanism of the invention (step 354), the STA switches from the scan mode to the connected mode (step 360). If it received a beacon from another STA with a matching SSID/BSSID that does not implement the mechanism of the invention (step 356), the STA switches from the scan mode to the connected mode (step 360). If a STA needs to transmit to another STA and the other STA is part of the sender's active STA list (step 358), the STA switches from the scan mode to the connected mode (step 360). Note that the transition is performed on the next scheduled wakeup period (maximum of SCAN_PERIOD latency).

Although the selection of parameters is not critical to the operation of the invention, the following suggestions are provided. The BEACON_PERIOD is preferably set to a value smaller then the SCAN_PERIOD. The BEACON_PERIOD is preferably set to the maximal tolerable latency for initial connection establishment. A reasonable value is 500 TU. The WAKEUP_PERIOD is preferably set to a value that is an integer division of the BEACON_PERIOD that enables reasonable data flow when a session is active. A reasonable value is 100 TU. The Short_Timeout is preferably configured as a multiple of the WAKEUP_PERIOD. A reasonable value is 2 WAKEUP_PERIODs (i.e. 1000 TU). The Long_Timeout is preferably set to a value larger than the Short_Timeout and should expand to cover an inactivity period that is reasonable from the user perspective of medium usage. A reasonable value is 10-30 seconds.

The results of test simulations run by the inventor are presented below. For the scan mode of operation, a STA scans for other STAs to establish an IBSS wherein it is assumed that the STA transmits beacons on its designated channel. The power consumption of a conventional STA was measured at ˜300 mW. For a STA implementing the low power IBSS mechanism of the invention, the power consumption drops significantly to approximately 1.3 mW.

For the standby mode of operation, the STA detects a connection but no traffic is present. It is assumed that a conventional STA transmits beacons at half rate, the ATIM window is 10 msec and the beacon period is 100 msec. In this scenario, a conventional STA consumes ˜200 mW while the power consumption of a STA implementing the low power IBSS mechanism of the invention drops significantly to approximately 1.3 mW.

For the active mode of operation (i.e. data transmission and reception), it is assumed that video streaming occurs in bursts every 1 second with an average rate of 300 kbps and a PHY rate of 24 Mbps. In this scenario, a conventional STA consumes ˜250 mW of power while the power consumption of a STA implementing the low power IBSS mechanism of the invention drops significantly to approximately 32 mW.

### Beacon Transmission Timing

The backoff used for the transmission of beacons for a STA that is part of an active IBSS is as follows. For beacons transmitted every WAKEUP_PERIOD, if the STA transmitted a beacon on the last WAKEUP_PERIOD, the backoff is CW=3 and AIFS=4*Number_Of_STAs+1. The value of ‘Number of STAs’ is the number of STAs in the IBSS that the STA is aware of (i.e. by monitoring their beacons). For every new beacon transmission attempt, the AIFS is reduced by 4 until it reaches 5. If the STA is the clock Source and it is an even SCAN_PERIOD (counted from TSF=0) then the backoff used is CW=3 and AIFS=1.

This setting is adapted to allow for a round robin approach with no collisions for beacon transmission from multiple IBSS STAs, while providing priority to the STA that is serving as the source making sure it is transmitting a beacon on every second SCAN_PERIOD in order to synchronize all other STAs in the network including the STAs that are currently scanning. Note that scheme could operate with no contention window (CW) but only based on fixed AIFS numbers. Since the number of STAs in the IBSS may not be known accurately on every moment, however, it is preferable to allow for some CW.

For beacons sent during a normal beacon period (i.e. there is active traffic to/from this STA), the beacon is transmitted with standard backoff/AIFS parameters. For STAs that are not in connected mode, the beacon is transmitted with the following parameters: CW=7 and AIFS=9. For a STA that just joined the IBSS, the initial beacon on the new IBSS is transmitted on a TBTT that is not an even SCAN_PERIOD with the following parameters: CW=3 and AIFS=1.

### Establishment of a Low Power IBSS Ad Hoc Network

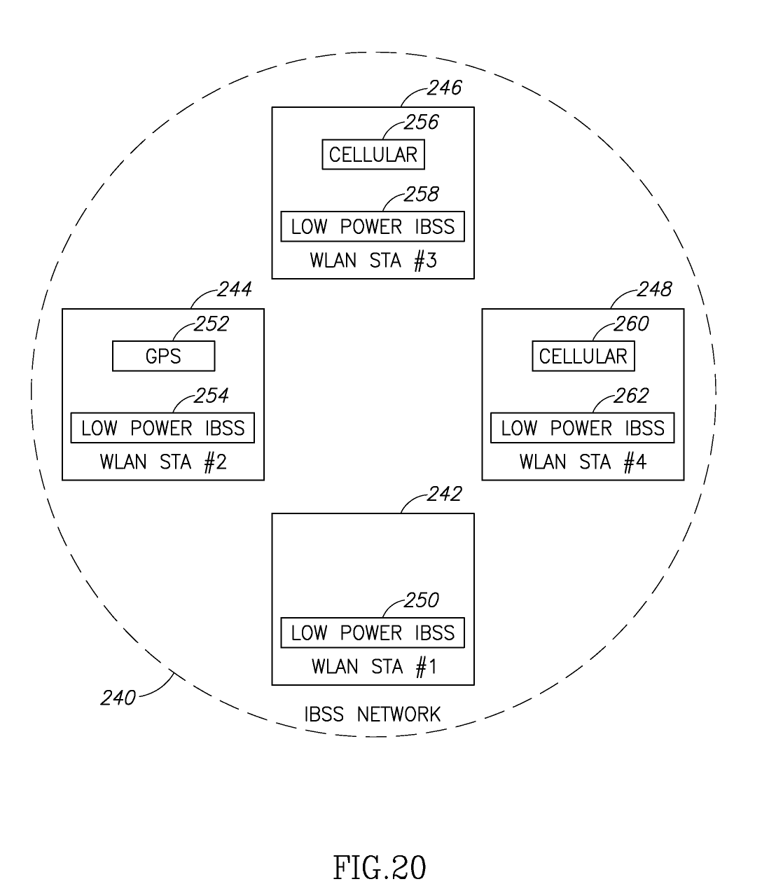

An example illustrating the principles of the present invention will now be presented. A diagram illustrating an example IBSS network is shown in FIG. 20. The example IBSS network, generally referenced 240, comprises four WLAN STAs, labeled STA #1 242, STA #2 244, STA #3 246 and STA #4 248. All the STAs implement the low power IBSS mechanism of the present invention. STA #1 comprises a low power IBSS block 250 but does not have access to an accurate clock source. STA #2 comprises a low power IBSS block 254 and an accurate timing source 252 (e.g., GPS in this example). STA #3 comprises a low power IBSS block 258 and an accurate timing source 256 (e.g., cellular in this example). Similarly, STA #4 comprises a low power IBSS block 262 and an accurate timing source 260 (e.g., cellular in this example).

The following is an illustration of the network establishment for an IBSS comprised only of WLAN STAs that implement the low power IBSS mechanism of the invention wherein two of the devices have access to the same accurate reference clock (i.e. STAs #3 and #4), another device has access to a different accurate clock (i.e. STA #2) and another device has no access to an accurate reference clock at all (e.g., STA #1).

The configuration of each of the four stations is presented below in Table 1. For each station the following information is listed: the activation time, whether the station has an access to an accurate timing source, the initial TSF with the offset configured and the services supported. Descriptions of Services 1, 2, 3 and 4 are defined below in Table 2.

TABLE 1
STA Configuration

| | | Internal | | |
|---|---|---|---|---|
| | Activation | clock | | Services |
| STA # | time | source | Initial TSF | supported |
| STA #1 | 0 | No | 0x40000000 0x00000000 | 1, 2 |
| STA #2 | 10.0 | Yes | 0x80000000 0x00020000 | 1, 2, 3 |
| STA #3 | 20.0 | Yes | 0x80000000 0x009A9680 | 1, 2, 3, 4 |
| STA #4 | 30.0 | Yes | 0x80000000 0x00F00000 | 1, 2, 3, 4 |

TABLE 2
Supported Services

| Service | Description |
|---|---|
| Service 1 | IP access |
| Service 2 | Internet gateway wherein the STA provides access to the |
| | internet |
| Service 3 | Voice communication wherein the STA is capable of voice |
| | communication using given application with other Ad Hoc |
| | stations |
| Service 4 | File server wherein the STA provides access to file system |
| | that can be read from remote device |

The flow of the network establishment is as follows. STA #1 is the first to come up. STA #1 performs a continuous scan for SCAN PERIOD but does not receive beacons from any STA since it is the only STA that is currently up. STA #1 starts transmitting beacons every SCAN_PERIOD. STA #1 is marked as a Source but is not in the connected state.

STA #2 comes up 10 seconds after STA #1 and it performs a scan for SCAN_PERIOD interval. It discovers STA #1 and joins its IBSS. STA #2 transmits a beacon with timing matching STA #1 SCAN_PERIOD interval, but with its own TSF indicating STA #2 as a Source. STA #1 receives this beacon and adjusts its TSF to match STA #2 which is now considered the Source. STA #2 transmits a Probe Request to STA #1 requesting a list of all known STAs and services. A Probe Response from STA #1 comprises information only about STA #1.

STA #3 comes up 10 seconds after STA #2. STA #3 performs a continuous scan for SCAN_PERIOD interval. It receives a beacon from either STA #1 or STA #2. Since STA #3 has an accurate internal clock source and since its TSF is higher then the existing Source, it defines itself as a Source. STA #3 sends a Probe Request to the STA that it received the Beacon from. The STA receiving the Probe Request replies with a Probe Response comprising information on all services supported by both STA #1 & STA #2. STA #3 transmits a beacon on the next SCAN_PERIOD. STA #1 and STA #2 receive the beacon and update their source to be STA #3. Since both STA #2 and STA #3 are synchronized to the same operator clock, the time correction when switching between them is lower then MAX_DRIFT and thus a double beacon procedure is not required.\

STA #4 comes up 10 seconds after STA #3. STA #4 performs a continuous scan for SCAN_PERIOD interval. It receives a beacon from either STAs #1, #2 or #3. Since STA #4 has an internal clock source and since its TSF is higher then the existing source, it defines itself as a Source. STA #4 sends a Probe Request to the STA that it received the Beacon from. The STA receiving the Probe Request replies with a Probe Response comprising information on all the services supported by both STA #1, #2 and #3. STA #4 transmits a Beacon on the timing matching STA #3 SCAN_PERIOD interval, but with its own TSF indicating STA #4 as the Source. STAs #1, #2 and #3 receive this beacon and adjust their TSF to match STA #4 and update their Source.

### Low Power IBSS Roaming

There are two distinct scenarios for the case of a low power IBSS ad hoc device in one IBSS roaming to the coverage area of another IBSS: (1) both low power IBSS networks share the same accurate clock source, or (2) the two low power IBSS networks have different sources (i.e. either two different accurate timing sources, no sources at all or a mixture thereof).

For the where case in which both low power IBSS networks share the same accurate clock source, STAs on both IBSS wakeup simultaneously and will hear each other Beacons. The two IBSSs then merge into a single network wherein the network with the higher TSF is used to define the TSF of the entire network as well as its IBSSID.

For the case in which the two low power IBSS networks have different sources, the timing of the two networks may be sufficiently apart to prevent one from hearing the other during their normal SCAN_INTERVAL wakeups. The two networks continue to coexist as separate networks until one of the STAs on either of the networks specifically requests a scan or attempts to send data to STAs that are not part of the IBSS. When this occurs, a scan lasting SCAN_INTERVAL is performed which will detect the existence of the other IBSS. The unification of the two IBSS is then performed by implementing the double beaconing procedure as described supra.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of power save operation for use in an ad hoc wireless local area network (WLAN) enabled communication device with access to an accurate timing source, said method comprising the steps of:
acquiring timing information from said accurate timing source;
translating said timing information to a time synchronization function (TSF) having a predetermined offset, said offset adapted to force stations that do not have access to an accurate timing source to synchronize with said communication device; and
publicizing said TSF to other stations in said ad hoc WLAN.

2. The method according to claim 1, further comprising the step of sending beacons incorporating a synchronization indication.

3. The method according to claim 2, wherein said synchronization indication is adapted to indicate whether said station is not synchronized, synchronized to one or more other stations that have access to an accurate timing source or is a timing source with access to an accurate timing source that is used to synchronize the entire ad hoc WLAN.

4. The method according to claim 1, further comprising the step of facilitating the discovery of said communication device by other stations within said ad hoc WLAN discovering by attempting to transmit a beacon every scan period.

5. The method according to claim 1, further comprising the step of advertising to other stations the services supported by said communication device.

6. The method according to claim 5, wherein said step of advertising comprises the step of including a list of said services supported by said communication device in beacon, probe requests or probe response packets.

7. The method according to claim 1, further comprising the step of subdividing a beacon period into a plurality of wakeup periods, whereby stations awake each wakeup period but transmit beacons every beacon period.

8. The method according to claim 1, further comprising the step of switching from a connected state to a lower power scan mode when no traffic is exchanged with said station for a predetermined time period.

9. The method according to claim 1, wherein said accurate timing source comprises a global positioning satellite (GPS) based timing source.

10. The method according to claim 1, wherein said accurate timing source comprises a cellular phone based timing source.

11. The method according to claim 1, wherein said method is implemented in a WLAN medium access control (MAC) within said communication device.

12. The method according to claim 1, wherein said method is implemented in a host device connected to said communication device.

13. A method of power save operation for use in an ad hoc wireless local area network (WLAN) enabled communication device, said method comprising the steps of:
generating a time synchronization function (TSF) having a predetermined offset, said offset adapted to force said communication device to synchronize with stations that do have access to an accurate timing source; and
publicizing said TSF to other stations in said ad hoc WLAN.

14. The method according to claim 13, further comprising the step of sending beacons incorporating a synchronization indication adapted to indicate whether said station is not synchronized, synchronized to one or more other stations that have access to an accurate timing source or is a timing source with access to an accurate timing source that is used to synchronize the entire ad hoc WLAN.

15. The method according to claim 13, further comprising the step of facilitating the discovery of said communication device by other stations within said ad hoc WLAN discovering by attempting to transmit a beacon every scan period.

16. The method according to claim 13, further comprising the step of advertising to other stations the services supported by said communication device.

17. The method according to claim 16, wherein said step of advertising comprises the step of including a list of said services supported by said communication device in beacon, probe requests or probe response packets.

18. The method according to claim 13, further comprising the step of subdividing a beacon period into a plurality of wakeup periods, whereby stations awake each wakeup period but transmit beacons every beacon period.

19. The method according to claim 13, further comprising the step of switching from a connected state to a lower power scan mode when no traffic is exchanged with said station for a predetermined time period.

20. The method according to claim 13, wherein said accurate timing source comprises a global positioning satellite (GPS) based timing source.

21. The method according to claim 13, wherein said accurate timing source comprises a cellular phone based timing source.

22. The method according to claim 13, wherein said method is implemented in a WLAN medium access control (MAC) within said communication device.

23. The method according to claim 13, wherein said method is implemented in a host device connected to said communication device.

24. A wireless local area network (WLAN) station, comprising:
a WLAN radio coupled to an antenna;
a PHY circuit coupled to said WLAN radio;
a medium access control (MAC) coupled to said PHY circuit, said MAC operative to;
generate a time synchronization function (TSF) having a predetermined offset, wherein said TSF and said predetermined offset are generated in accordance with whether said station has access to an accurate timing source;
publicize said TSF to other stations in an ad hoc WLAN; and
a host interface operative to interface said station to an external host.

25. The station according to claim 24, wherein, if said station has access to an accurate timing source, said MAC is operative to:
translate timing information from said accurate timing source to generate said TSF; and
set said predetermined offset to a first offset value adapted to force other stations that do not have access to said accurate timing source to synchronize with said station.

26. The station according to claim 24, wherein, if said station does not have access to an accurate timing source, said MAC is operative to generate said TSF with said predetermined offset set to a second offset value adapted to force said station to synchronize with other stations that do have access to an accurate timing source.

27. The station according to claim 24, wherein said MAC is further operative to advertise to other stations the services supported by said station.

28. The station according to claim 24, wherein said MAC is further operative to include a list of said services supported by said station in beacon, probe requests or probe response packets.

29. The station according to claim 24, wherein said MAC is further operative to subdivide a beacon period into a plurality of wakeup periods, whereby said station awakes each wakeup period but transmits beacons every beacon period.

30. The station according to claim 24, wherein said MAC is further operative to switch from a connected state to a lower power scan mode when no traffic is exchanged with said station for a predetermined time period.

31. A mobile communications device, comprising:
a WLAN station comprising a medium access controller (MAC);
said MAC operative to:
generate a time synchronization function (TSF) having a predetermined offset, wherein said TSF and said offset are generated in accordance with whether said station has access to an accurate timing source;
publicize said TSF to other stations in an ad hoc WLAN; and
advertise services supported by said station in beacon messages transmitted from said station to other stations in said ad hoc WLAN.

32. The mobile communications device according to claim 31, further comprising:
an accurate timing source;
said MAC comprising means operative to:
translate timing information from said accurate timing source to generate said TSF; and
set said predetermined offset to a first offset value adapted to force other stations that do not have access to said accurate timing source to synchronize with said station.

33. The station according to claim 31, wherein said MAC is operative to generate said TSF with said predetermined offset value set to a second offset value adapted to force said station to synchronize with other stations that do have access to an accurate timing source.

34. A method of reducing scan time of an ad hoc wireless local area network (WLAN), said method comprising the steps of:
acquiring timing information from an accurate timing source available to at least one communication device in said ad hoc WLAN;
translating said timing information to a time synchronization function (TSF) having a predetermined offset, said offset adapted to force stations that do not have access to an accurate timing source to synchronize with said communication device;
publicizing said TSF to other stations in said ad hoc WLAN; and
activating scanning on a predetermined frequency and during a time window determined based on said accurate timing source.
